(19) United States
(12) Patent Application Publication
(10) Pub. No.: US 2010/0011044 A1
(43) Pub. Date: Jan. 14, 2010

(54) Device and method for determining and applying signal weights

(76) Inventor: James Vannucci, McDonald, PA (US)

Correspondence Address: James Vannucci, 5212 Forest View Drive, McDonald, PA, 15057, US

(21) Appl. No.: 12/453,092

(22) Filed: Apr. 29, 2009

Related U.S. Application Data
(63) Continuation-in-part of application No. 12/218,052, filed on Jul. 11, 2008.

(51) Int. Cl. G06F 17/14; G06F 17/16

(52) U.S. Cl. 708/404; 708/400; 708/607

(57) ABSTRACT

The solution X₀ to an initial system of equations with a Toeplitz coefficient matrix T₀ can be efficiently determined from an approximate solution X to a system of equations with a coefficient matrix T that is approximately equal to the coefficient matrix T₀. Iterative updates can be performed to improve the accuracy of the approximate solution X.

### CROSS-REFERENCE TO RELATED APPLICATIONS

This application is a Continuation in Part of U.S. Ser. No. 12/218,052 filed on Jul. 11, 2008, incorporated herein by reference.

### STATEMENT REGARDING FEDERALLY SPONSORED RESEARCH OR DEVELOPMENT

Not applicable.

### REFERENCE TO A COMPUTER PROGRAM LISTING COMPACT DISC APPENDIX

Not applicable.

### BACKGROUND OF THE INVENTION

The present invention concerns devices and methods for determining and applying signal weights. Many devices, including sensing, communications and general signal processing devices, require the determination and application of signal weights for their operation. The disclosed device can be used as a component for such sensing, communications and general signal processing devices.

Communications devices typically input, process and output signals that represent transmitted data, speech or image information. The devices can be used in any known communications systems. The devices usually use digital forms of these signals to generate a covariance matrix, and a known vector, in a system of equations that must be solved for the operation of the device. The covariance matrix may be Toeplitz or approximately Toeplitz. The solution to this system of equations is a weight vector that is usually applied to a signal to form the output signal of the device. The disclosed methods permit the use of a greater number of weight coefficients, and also produces a large increase in processing speed which improves performance. Solving larger systems of equations permits the device to use more past information from the signals in determining any filter weights.

Sensing devices typically collect an input signal with an array of sensors, and convert this signal to a digital electrical signal that represents some type of physical target, or physical object of interest. The digital signals are usually used to generate a covariance matrix, and a known vector in a system of equations that must be solved for the operation of the device. The covariance matrix may be Toeplitz, or approximately Toeplitz. The solution to this system of equations is a weight vector that can be used with a signal to calculate another signal that forms a beam from the sensor array. The weight vector can also contain information on the physical object of interest. The performance of the sensing device is usually directly related to the dimensions of the system of equations. The dimensions usually determine the resolution of the device, and the speed with which the system of equations can be solved. Increasing the solution speed improves tracking of the target, and determining the position of the target in real time. The use of larger sensor arrays results in a much narrower beam for resistance to unwanted signals. The disclosed methods solve systems of equations with large dimensions in sensing devices significantly faster than other methods in the prior art.

General signal processing devices include devices for control of mechanical, chemical and electrical components, artificial neural networks, speech processing devices, image processing devices, devices relying on linear prediction methods for their operation, system identification devices, data compression devices, and devices that include digital filters. These devices typically process electrical signals that represent a wide range of physical quantities including identity, position and velocity of an object, sensed images and sounds, and data. The signals are usually digitized, and used to generate a covariance matrix and a known vector in a system of equations that must be solved for the operation of the device. The covariance matrix may be approximately Toeplitz, or Toeplitz. The solution to this system of equations is a weight vector that is usually used to determine the output of the device. The weight vector can be used to filter a signal to obtain a desired signal. The performance of the device is usually directly related to the dimensions of the system of equations. The dimensions of the system of equations usually determines the maximum amount of information any weight vector can contain, and the speed with which the system of equations can be solved. The disclosed methods solve systems of equations with large dimensions in signal processing devices with improved efficiency.

The signal weights are determined by solving a system of equations with a Toeplitz, or approximately Toeplitz, coefficient matrix. The solution methods in the prior art for systems of equations with Toeplitz coefficient matrices can be briefly summarized with the following methods. Iterative methods can be used to obtain a solution to a system of equations with a Toeplitz coefficient matrix. These iterative methods include methods from the conjugate gradient family of methods. Fast direct methods such as the Levinson type methods, and the Schur type recursion methods, can also be used on Toeplitz coefficient matrices to obtain a solution in O(2n²) steps. Super fast direct methods are methods that can obtain a solution in fewer than O(n²) steps. Iterative methods can be fast and stable, but can also be slow to converge for many systems. The fast direct methods are stable and fast. The super fast direct methods have not been shown to be stable for Toeplitz matrices that are not well conditioned, and many are only asymptotically super fast. The disclosed methods are faster than these methods. The disclosed methods also require fewer memory accesses, and less memory storage than the direct methods.

The following devices are a few of the many devices that require determining and applying signal weights for their operation and that can use the disclosed device as a component. The following disclosures are incorporated by reference in this application. Sensing devices including Radar and Sonar devices as disclosed in Zrnic (U.S. Pat. No. 6,448,923), Bamard (U.S. Pat. No. 6,545,639), Davis (U.S. Pat. No. 6,091,361), Pillai (2006/0114148), Yu (U.S. Pat. No. 6,567,034), Vasilis (U.S. Pat. No. 6,044,336), Garren (U.S. Pat. No. 6,646,593), Dzakula (U.S. Pat. No. 6,438,204), Sitton et al. (U.S. Pat. No. 6,038,197) and Davis et al. (2006/0020401). Communications devices including echo cancellers, equalizers, and devices for channel estimation, carrier frequency correction, speech encoding, mitigating intersymbol interference, and user detection as disclosed in Oh et al. (U.S. Pat. No. 6,137,881), Ding (US 2006/0039458), Kim et al. (US 2005/0123075), Hui (2005/0276356), Tsutsui (2005/0254564), Dowling (US 2004/0095994), and Schmidt (U.S. Pat. No. 5,440,228). Signal processing devices including devices that comprise an artificial neural network as disclosed in Hyland (U.S. Pat. No. 5,796,920), that control noise and vibration as disclosed in Preuss (U.S. Pat. No. 6,487,524), and that restore images as disclosed in Trimeche et al. (2006/0013479).

### SUMMARY OF THE INVENTION

A signal weight vector can be determined by solving a system of equations with a Toeplitz coefficient matrix. A system of equations with a Toeplitz coefficient matrix T₀ can be extended to a system of equations having larger dimensions. The extended coefficient matrix T is Toeplitz. The matrix T can be modified to a preferred form. The matrix T can then be separated into a sum of matrix products, where the matrices that comprise the matrix products can be approximated by matrices with improved solution characteristics. The system of equations with a coefficient matrix T can now be solved with increased efficiency. The solution to the system of equations with the coefficient matrix T₀ is then obtained from this solution by iterative methods. The final solution is a vector of weights that are applied to a signal. Additional unknowns are introduced into the system of equations when the matrix T is larger than the matrix T₀, and also when the matrix T is modified. These unknowns can be determined by a number of different methods.

Devices that require the determination of signal weights, and the application of these signal weights to known signals, can use the disclosed methods to achieve large increases in their performance. A device comprising the disclosed methods can also be used as a component in any of these devices. The disclosed methods have parameters that can be selected to give the optimum implementation of the methods. The values of these parameters are selected depending on the particular device in which the methods are implemented.

### BRIEF DESCRIPTIONS OF THE DRAWINGS

FIG. 1 shows the disclosed device as a component in a signal processing device.

FIG. 2 is a block diagram showing the components of the disclosed device.

### DETAILED DESCRIPTION

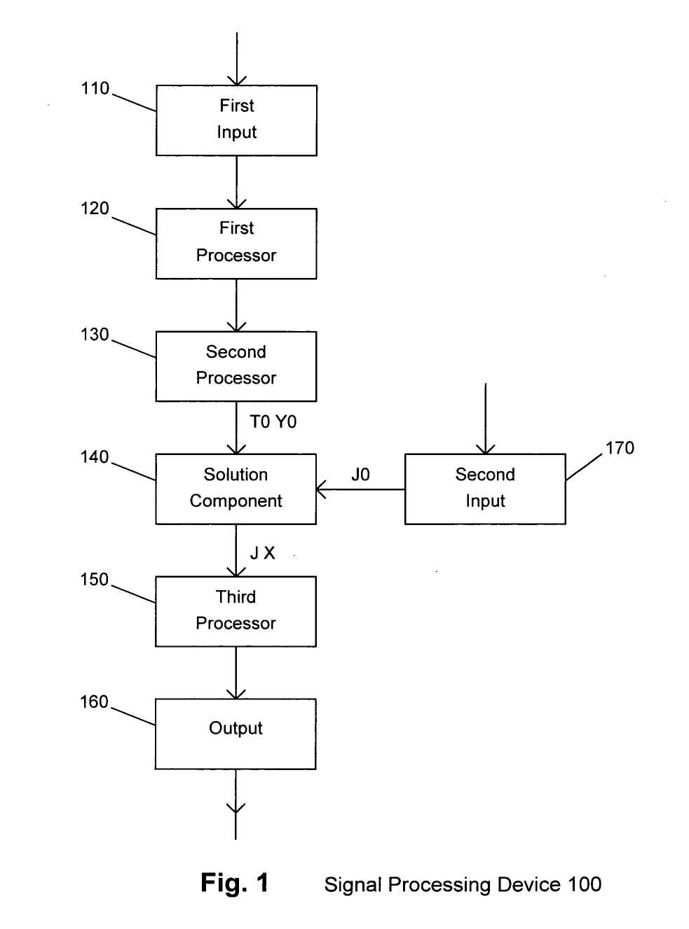

FIG. 1 shows a non-limiting example of a signal processing device 100 that requires the determination of signal weights and the application of these signal weights for its operation. A first input 110 is the source for at least one signal to be processed by a first processor 120. A second processor 130 forms a system of equations with a Toeplitz, or approximately Toeplitz, coefficient matrix T₀, and a vector Y₀ with the processed signals from the first processor 120. This system of equations is solved by the solution component 140 disclosed in this application to obtain a vector of signal weights X. The solution component 140 receives signals J₀ from a second input 170, and processes the signals J₀ with the signal weights X to obtain signals J. The signals J₀ may be processed before it is received by the solution component 140. The signals J₀ may be signals from the first input 110 or the first processor 120. The signals J from the solution component 140 are processed by a third processor 150 to form signals sent to the output 160. Not all devices require that the signals J be calculated. For these devices, the vector X is the output of the solution component 140. Many devices do not have all of these components. For many devices, each component has many sub-components. The device may also have many additional components, and include feedback from the output 160, or the third processor 150, to another component such as the first processor 120 or the second processor 130. The signals from the second input 170 can be one or more of the signals from the first input 110, or signals from the first processor 120.

The signal processing device shown in FIG. 1 can be a communications device, a sensing device, or a general signal processing device. Signal processing devices are well known in the art. Sensing devices include active and passive radar, sonar, medical and seismic devices. For these devices, the first input 110 is a sensor or a sensor array. The first processor 120 can include, as non-limiting examples, one or more of the following for processing a signal from the first input component 110: a decoder, digital filters, and a sampler to convert the analog signal to a digital signal. The second processor 130 usually forms the coefficient matrix T₀ from a covariance matrix generated from sampled aperture data from one or more sensor arrays. If the array elements are linear and equally spaced, the covariance matrix usually is Hermetian and Toeplitz. The known vector Y₀ can be a steering vector or a data vector. The vector X usually contains signal weights to be applied to signals J₀ to obtain signals J that form a beam pattern. The vector X and the signal J can also include tangible information concerning the sensed objects. The solution component 140 solves the system of equations for the weight vector X, then applies the weight vector to signals J₀ from the second input component 170 to produce signals J. The output component 160 can be a display device for target information or a sensor array.

Communications devices include echo cancellers, equalizers, and devices for channel estimation, carrier frequency correction, speech encoding, mitigating intersymbol interference, and user detection. For these devices, the first input 110 usually comprises hardwire connections, or an antenna. The first processor 120 can include, as non-limiting examples, one or more of the following for processing signals from the first input 110: an amplifier, receiver, demodulator/modulator, digital filters, a sampler, decoder and down/up converter. The second processor 130 usually forms the coefficient matrix T₀ from a covariance matrix generated from one of the processed input signals that usually represents speech, images or data. The covariance matrix is usually symmetric and Toeplitz. The known vector Y₀ is usually a crosscorrelation vector between two processed signals that usually represent speech, images or data. The vector X contains signal weights. The solution component 140 solves the system of equations for the signal weights, and filters signals J₀ by applying the signal weights to the signals J₀ to form the signals J. The signals J₀ from the second input 170 can be the same signals as those signals from the first input 110. The signals J represents transmitted speech, images or data. The output component 160 can be a hardwire connection, an antenna, or a display device.

General signal processing devices include a wide range of devices. For these devices, the first input 110 usually comprises hardwire connections, or a sensor. The first processor 120 can include many types of components that prepare the input signals so they can be used by the second processor 130 to form the coefficient matrix T₀. Usually the coefficient matrix is formed from a covariance matrix. For some devices, the coefficient matrix is a selected function such as a Markov or Greene's function. The covariance matrix is usually Hermetian and Toeplitz. The vector Y₀ is usually a vector formed from a crosscorrelation operation with two processed signals. The vector Y₀ can also be an arbitrary vector. The matrix T₀ and the vector Y₀ usually represent a physical quantity such as an image, a frame of speech, data, or information concerning a physical object. The vector X usually represents signal weights, but can also represent a compressed portion of data, an image, a frame of speech or, prediction coefficients, depending on the application. The solution component 140 solves the system of equations for the X vector, then usually processes the X vector with a signal J₀ from the second input 170, to form a desired signal J. The output component 160 can be a hardwire output, a display, an actuator, an antenna or a transducer of some type. The physical significance of T₀, Y₀ J and X is dependent upon, and usually the same as, the physical significance of the signals in the general signal processing device. The following are non-limiting examples of general signal processing devices.

For devices that control mechanical, chemical, biological and electrical components, the matrix T₀ and the vector Y₀ can be formed from processed signals that are usually either collected by a sensor, or that are associated with a physical state of an object that is to be controlled. The signals are usually sampled after being collected. The vector X contains filter weights used to generate a control signal J that usually is sent to an actuator or display of some type. The physical state of the object can include performance data for a vehicle, structural damage data, medical information from sensors attached to a person, vibration data, flow characteristics of a fluid or gas, measureable quantities of a chemical process, and motion, power, and temperature data.

For an artificial neural network with a Toeplitz synapse matrix, the matrix T₀ and the vector Y₀ are formed by autocorrelation and cross-correlation methods from training signals that represent speech, images and data. These signals represent the type of signals processed by the artificial neural network. The vector X contains the synapse weights. The signal J represents images and data that are processed with the vector X.

For speech, image and EEG processing devices, the matrix T₀ and the vector Y₀ can be formed from signals representing speech, images, and EEG data. The vector X can contain model parameters or signal weights. The signal weights can be used to filter a signal J₀ to obtain a signal J. The signal J can represent speech, image and EEG information. The vector X can be model parameters used to characterize or classify the signals that were used to calculate T₀ and Y₀. In this case, the vector X is the output of the solution component 140 and has the same physical significance as T₀ and Y₀. Calculating the signal J may not be required. As a non-limiting example, T₀ can be a gaussian distribution, Y₀ can represent an image, and X can represent an improved image. Calculating the signal J here may not be required. The vector X is the output of the solution component 140.

For filtering devices, the matrix T₀ and the vector Y₀ can be formed by autocorrelation and cross-correlation methods from sampled signals that represent voice, images and data. The vector X contains filter coefficients that are applied to signals J₀ to produce desired signals J that represent voice, images and data. The device may also provide feedback to improve the match between the desired signal, and the calculated approximation to the desired signals. The signals J₀ can be one or more of the signals that were used to form the matrix T₀ and the vector Y₀.

For devices relying on linear prediction or data compression methods for their operation, the matrix T₀ is usually an autocorrelation matrix formed from a sampled signal that represents a physical quantity including speech, images or general data. The vector Y₀ can have all zero values except for its first element, and the vector X contains the prediction coefficients that represent speech, images or data. The signals J₀ may be filtered by the vector X to obtain the signals J, which represent predicted speech, images or data. The signals J may not be calculated if the vector X is the device output. In this case, the vector X represents the same quantities that the signals used to calculate T₀ and Y₀ represent, including speech, images and data.

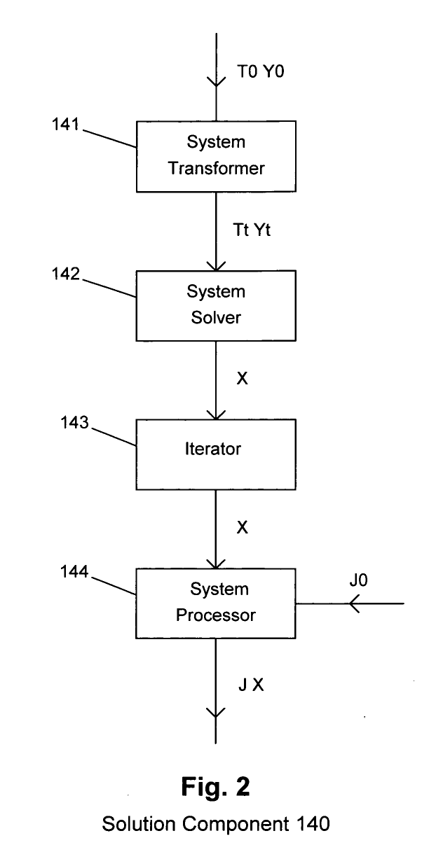

FIG. 2 discloses the solution component 140 in greater detail. A system transformer 141 increases the dimensions of the system of equations (1) with pad rows and columns, separates the coefficient matrix, alters selected rows and columns of the coefficient matrix by adding modifying rows and columns to the coefficient matrix, and then forms a transformed system of equations. The vectors X₀ and Y₀, and the coefficient matrix T₀, represent the above disclosed physical quantities.

T₀X₀=Y₀ (1)

The system transformer 141 forms the system of equations (2). The matrix A results from the matrix T having larger dimensions than the matrix T₀, and from modifications made to row and columns of the matrix T₀. The vector S contains unknowns to be determined. The matrix A and vector S can comprise elements that improve the solution characteristics of the system of equations, including improving the match between the matrices T and T₀, lowering the condition number of the matrix T, and making a transform of the matrix T, matrix Tₜ, real. Matrices A and B comprise modifying rows and columns that alters elements in the T₀ matrix. Matrix A also contains columns with nonzero elements that correspond to pad rows used to increase the dimensions of the matrix T₀ those of the matrix T. The vectors X and Y are the vectors X₀ and Y₀, respectively, with zero pad elements that correspond to rows that were used to increase the dimensions of the system of equations.

TX=Y+AS

BX=S (2)

The system transformer 141 separates the matrix T into a sum of the products of diagonal matrices D₁ᵢ, circulant matrices Cᵢ and diagonal matrices D₂ᵢ. The elements in the diagonal matrices D₁ᵢ and D₂ᵢ are given by exponential functions with real and/or imaginary arguments, trigonometric functions, elements that are either zero, one or minus one, elements that are one for either the lower or upper half of the principal diagonal elements, and negative one for the other upper or lower half of the principal diagonal elements, elements determined from other elements in the diagonal by recursion relationships, and elements determined by factoring or transforming the matrices containing these elements. The sum (3) is over the index i.

T=ΣD₁ᵢCᵢD₂ᵢ (3)

As a non-limiting example, the matrices D₁₀ and D₂₁ can be set equal to each other and can have the elements along their principal diagonal defined by a decreasing exponential function with a real negative argument α. The matrices D₂₀ and D₁₁ can be set equal to each other and can have the elements along their principal diagonal defined by an increasing exponential function with a real positive argument α. In a non-limiting example, α can be a complex constant.

T=D₁₀C₁D₂₀+D₂₀C₂D₁₀

The matrix T can be further factored into a form (4) that comprises quotients of upper matrices Uᵣᵢ divided by lower matrices Lᵣᵢ. The diagonal elements in the matrices Dᵣᵢ can be approximated by a quotient of matrices Uᵣᵢ divided by matrices Lᵣᵢ. The upper matrices Uᵣᵢ and lower matrices Lᵣᵢ can comprise the identity matrix I. Some or all of the lower matrices Lᵣᵢ can be identical. At least one of the matrices Uᵣᵢ, Lᵣᵢ and Cᵢ have elements that are given by a sum over a set of expansion functions. The choice of expansion functions is usually determined by matrices T_{L} and T_{R} that are used to transform the system of equations with the T matrix. The expansion functions are selected such that the transform of the matrices with the elements given by a sum over the expansion functions have a desirable form. The summation is over the index i, and has an arbitrary range. As a non-limiting example, the matrices L₁₀ and L₂₀ can be set equal to each other.

$$T ≅ \sum \frac{{U}_{1 i}}{{L}_{1 i}} {C}_{i} \frac{{U}_{2 i}}{{L}_{2 i}} \qquad ( 4 )$$

The system transformer 141 forms the transformed system of equations (5). The term (π[Lᵣᵢ]) is the product of Lᵣᵢ matrices, but can include a single term. The T_{L} and T_{R} matrices are transform matrices, and can comprise any discrete matrix transforms that are used to transform the Lᵣᵢ, Uᵣᵢ and Cᵢ matrices, and any matrix derived from one or more of the Uᵣᵢ and Lᵣᵢ matrices. The Cᵢ, Uᵣᵢ and Lᵣᵢ matrices, where subscript r is either 1 or 2, are defined such that a transform of these matrices, Cᵢₜ, U₁ᵢₜ, U₂ᵢₜ, L₁ᵢₜ and L₂ᵢₜ, have a desirable form that permits a solution to a system of equations with improved efficiency.

(ΣU₁ᵢₜCᵢₜU₂ᵢₜ)Xₜ=Yₜ+AₜS (5)

Aₜ=T_{L}(πL₁ᵢ)A

Yₜ=T_{L}(πL₁ᵢ)Y

Xₜ=(inv T_{R}) (πinv L₂ᵢ)X

Cᵢₜ=T_{L}CᵢT_{R}

Uᵣᵢₜ=T_{L}UᵣᵢT_{R}

Lᵣᵢₜ=T_{L}LᵣᵢT_{R}

I=T_{L}T_{R}=T_{R}T_{L}

Examples of matrices with a desirable form include, but are not limited to, matrices in the group comprising matrices that are banded, diagonal, approximately banded, diagonally dominant, diagonal with a few additional rows and columns, banded with a few additional rows and/or columns, circulant, Hankel, and matrices that are modifications and approximations of these forms. The transform that transforms the Cᵢ, Uᵣᵢ and Lᵣᵢ matrices can be any transform known in the art including, but not limited to, transforms in the groups comprising any type of discrete Fourier, wavelet, Hartley, sine, cosine, Hadamard, Hough, Walsh, Slant, Hilbert, Winograd, and Fourier related transform. The Cᵢ, Uᵣᵢ and Lᵣᵢ matrices can take any form. Usually, T_{R} and T_{L} are a type of discrete fast Fourier transform (FFT), and inverse discrete fast Fourier transform (iFFT). The matrices U₁ᵢₜ and L₁ᵢₜ are usually chosen to be narrow banded, and the matrices Cᵢₜ are usually chosen to be diagonal matrices.

The weight constants of the expansion functions can be determined by any regression methods, including non-linear regression methods. The expression (6) can be used to determine the weight constants for expansion functions fn1 and fn2 after they have been selected. Regression methods are well known in the art. If the matrices Uᵣᵢ and Lᵣᵢ are diagonal matrices, the function g (i) can represent the i-th element in the diagonal of one of the Uᵣᵢ/Lᵣᵢ quotients. The g(i) function can be approximately expanded in terms of the expansion functions fn1 and fn2 (6).

$$g ( i ) ≅ \frac{\sum {A}_{m} fn 1 ( {w}_{m} i ) + \sum {B}_{m} fn 2 ( {w}_{m} i )}{\sum {C}_{m} fn 1 ( {w}_{m} i ) + \sum {D}_{m} fn 2 ( {w}_{m} i )} + err ( i ) \qquad ( 6 )$$

The g(i) elements that correspond to pad and modified rows and columns are usually not included in the methods used to obtain values for the weight constants. Once the weight constants have been determined, values for these elements corresponding to pad and modified rows and columns are calculated. These values are then used in place of the original values in the matrices, and determine the pad and modifying rows and columns. Other methods in the prior art can also be used to determine the weight constants for each matrix.

An iterative weighted least squares algorithm (7) can be used to determine the weight constants for the expansion functions. For the nonlimiting example when the transform matrices are FFTs, the expansion functions are sine and cosine functions. The function g(i) designates the value of the i-th diagonal element in one of the Uᵣᵢ/Lᵢᵣ quotients matrices. The sum of the squares of the errors between the function g(i) and an approximate expansion for the function g(i) is given by the following expression for sine and cosine expansion functions. The first summation is over the index i, and the second summation is over the index m.

Σ(g(i)(ΣAₘ cos(wₘi)+ΣBₘ sin(wₘi))−ΣCₘ cos(wₘi)+ΣDₘ sin(wₘi))²/Bₚ(i) (7)

This equation is partially differentiated with respect to each weight constant to obtain a system of equations that can be solved for the weight constants. Here Bₚ(i) is constant and initially unity for all i. For each subsequent iteration, the system of equations (7) is solved with values of Bₚ(i) based on the previous weight constant values (8). The sum is over the index m.

Bₚ(i)=ΣAₘ cos(wₘi)+ΣBₘ sin(wₘi) (8)

The values of the elements in the matrices Uᵣᵢ and Lᵣᵢ are given by a sum of sine and cosine functions whose magnitudes are selected such that the elements in the principal diagonal of the matrices Dᵣᵢ are approximately a quotient, Uᵣᵢ/Lᵣᵢ. The sum, m, over the expansion functions of the Uᵣᵢ and Lᵣᵢ matrices, is limited to a few arbitrary terms. The transform of the matrices Uᵣᵢ and Lᵣᵢ, Uᵣᵢₜ and Lᵣᵢₜ, respectively, are banded matrices.

Uᵣᵢ(i)=ΣAᵣᵢₘ cos(wₘi)+ΣBᵣᵢₘ sin(wₘi) (9)

Lᵣᵢ(i)=ΣCᵣᵢₘ cos(wₘi)+ΣDᵣᵢₘ sin(wₘi) (10)

Other sets of transform matrices T_{L} and T_{R}, and matrices Cᵢ, Lᵣᵢ and Uᵣᵢ can be formed by factoring the above matrices from the non-limiting case where the transform matrices are FFT and iFFT matrices, the Cᵢ matrices are circulant, and the Lᵣᵢ and Uᵣᵢ matrices are banded. The products in the sum of products that comprise the matrix T can be multiplied out with the resulting terms recombined into matrices with a different form than the original matrices Cᵢ, Uᵣᵢ and Lᵣᵢ. Any of the transform matrices T_{R} and T_{L}, or the matrices Cᵢ, Lᵣᵢ and Uᵣᵢ, can have matrices factored out from them with the factored matrices forming a product with another transform matrix, or matrix Cᵢ, Lᵣᵢ or Uᵣᵢ, to obtain a different set of matrices. Other sets of transform matrices, and matrices Cᵢ, Lᵣᵢ and Uᵣᵢ, can also be formed by approximating the above matrices from the nonlimiting example with matrices that have elements with approximate values, or with matrices that have a similar or related form. A matrix with a similar or related form has elements arranged in a similar pattern, or elements that can be rearranged to obtain a similar pattern. Also, the matrices Cᵢ, Lᵣᵢ and Uᵣᵢ from the nonlimiting example can be altered with additional rows and columns, and diagonals of nonzero elements, to form another set of matrices. Only a small number of nonzero weight constants are required to obtain a matrix T that is sufficiently accurate to approximate the Toeplitz matrix T₀. The matrix T usually deviates the most from the Toeplitz form for rows and columns on the edges of the matrix T₀. These outer rows and columns form a border region surrounding the more Toeplitz region of the matrix T.

The system solver 142 of FIG. 2 solves the transformed system of equations (11). The system solver uses methods known in the art for solving the transformed systems of equations including, but not limited to, gauss elimination, iterative methods, and any known decomposition methods, including decomposition methods lower diagonal upper LDU, singular value decomposition SVD, eigenvalue decomposition EVD, QR decomposition, and Cholesky decomposition methods. The iterative methods include Trench's algorithms, and methods from the conjugate gradient family of methods. The transformed system of equations (11) has the matrix Aₜ separated into a portion Aₚₜ corresponding to pad rows, and a portion A_{qt} corresponding to modifying rows and columns. In some cases, the transformed system of equations (11) can be separated into real and imaginary equations by the system solver 142 that can be solved simultaneously. In some cases, the transformed system of equations (11) can be separated into systems of equations by the system solver 142 with vectors that are either symmetric or skew symmetric. These different separations can result in new systems of equations where the corner bands of a new coefficient matrix can be combined with elements in the principal diagonal band of the new coefficient matrix to form a new coefficient matrix with a single narrow band.

(ΣU₁ᵢₜCᵢₜU₂ᵢₜ)Xₜ=Yₜ+AₚₜSₚ+A_{qt}S_{q} (11)

The unknown vector S comprises vectors Sₚ and S_{q}, and these vectors can be determined by the system solver 142 using the following methods in either the transformed or reversed transformed space. The transformed vector Xₜ, and the reverse transformed vector X, are given by the following expressions.

Xₜ=X_{yt}+XₐₚₜSₚ+X_{aqt}S_{q} (12)

X=X_{y}+XₐₚSₚ+X_{aq}S_{q} (13)

The S_{q} column vector can be approximated by equation (14). The matrix B_{q} includes the rows that were used to modify the T₀ matrix to form the matrix T. The matrix B_{qt} is the transform of the matrix B_{q}. The matrix Bₚ includes the rows that were used to increase the dimensions of the system of equations.

B_{qt}Xₜ=S_{q}

BₚX=Sₚ

B_{q}X=S_{q} (14)

The system solver 142 reverse transforms equation (12) to obtain equations (15) and (16) for the vectors Sₚ and S_{q} respectively. Equation (15) for determining the vector Sₚ results from the first p rows of equation (13). Once the values of the S vector are determined, the system solver 142 calculates their contribution to the values of either the X or Xₜ vectors using equation (17).

X_{y}=−XₐSₚ (15)

(I−BₜXₐ)S_{q}=BₜX_{y} (16)

X=X_{y}+XₐS (17)

If the matrix T is a sufficient approximation to the matrix T₀, the solution to equation (2) can be used as the solution to equation (1). If the solution to equation (2) is not a sufficient approximation to the solution for equation (1), the solution to equation (1) can be calculated by the iterator 143 of FIG. 2 from the solution to equation (2) by any methods known in the art. These methods include obtaining an update to the solution X by taking the solution X and using it as the solution to equation (1). The difference between the Y₀ vector, and the product of the matrix T₀, and the solution X, is then used as the new input column vector Yₐ for equation (2). The vectors Yₐ and X are approximately equal to the vectors Y₀ and X₀, respectively. The vectors X and Yₐ are zero padded vectors.

T₀X₀=Y₀

TX=Y₀+AS

T₀X=Yₐ (18)

TXᵤ=Y₀−Yₐ+ASᵤ (19)

X₀=X+Xᵤ (20)

The vector Xᵤ is the first update to the vector X. These steps can be repeated until a desired accuracy is obtained. Most quantaties have already been calculated for each of the updates.

The system processor 144 uses the vector X to filter the signals J₀ to form the signals J. The vector X contains weights that are applied to the elements of the signals J₀. The signals J are the output of the solution component 140. The signals J can be calculated by the product of the vector X and the transpose of the vector J₀. Both J and J₀ can be a single signal instead of signals. For devices 100 that do not require calculating the signal J, the vector X is the output of the solution component 140.

If the coefficient matrix T is constant or slowly changing, it can be approximated by the sum of a difference matrix t and the previous coefficient matrix Tᵢ. The changes in vectors X, S and Y can be represented by difference vectors x, s and y. The difference vector x can be obtained from equation (21). The solution X can be obtained from the sum of vector x and the previous solution vector Xᵢ. The y and x vectors are padded with zeroes in rows corresponding to pad rows and columns. The matrix t can contain all zero elements. The system transformer 141 forms and transforms the following equation.

Tx=y−tX+As (21)

The matrix t can also be the difference between the coefficient matrix T₀, and a previous coefficient matrix T₀ᵢ. The vector y is the difference between the vector Y₀ and a previous vector Y₀ᵢ. The update to the column vector s is calculated by the system solver 142 as follows.

(I−BT⁻¹A)s=BT⁻¹(y−tX) (22)

Further improvements in efficiency can be obtained if the coefficient matrix is large, and the inverse of the coefficient matrix T₀ has elements whose magnitude decreases with increasing distance from the principal diagonal. The system transformer 141 zero pads the vector X by setting selected rows to zero. The vector X is then split into a vector X_{yr} and a vector Xᵣ. The vector X_{yr} is first calculated from equation (23), then additional selected row elements at the beginning and at the end of the vector X_{yr} are set to zero. The vector Xᵣ is then calculated from equation (24). The matrix Tₛ contains elements of either the matrix T₀, or the matrix T that correspond to non-zero elements in the vector Xᵣ, These are usually elements from the corners of the matrix T. The non-zero elements in the vector Xᵣ are the additional selected row elements set to zero in the vector X_{yr}. The system transformer 141 transforms equations (23) and (24) for solution by the system solver 142.

TX_{yr}=Y₀ (23)

TₛXᵣ=Y₀−TX_{yr} (24)

The implementation of the disclosed methods on a specific device depends on the particular solution characteristics of the system of equations that is solved by the particular device. Depending on the devices, different portions of the methods can be performed on parallel computer architectures. When the disclosed methods are implemented on specific devices, method parameters like the matrix Tₜ, bandwidth m, the number of pad and modified rows p and q, and the choice of hardware architecture, must be selected for the specific device. Many devices require the solution of a system of equations where the coefficient matrix is a covariance matrix that is not exactly Toeplitz. There are a number of methods that can be used to approximate a covariance matrix that is not exactly Toeplitz with a Toeplitz matrix. These methods include using any statistical quantity to determine the value of the elements on a diagonal of a Toeplitz matrix from the elements on a corresponding diagonal of a covariance matrix.

Devices that implement the disclosed methods can obtain substantial increases in performance by implementing the methods on single instruction, multiple data SIMD-type computer architectures known in the art. The vector X_{y}, and the columns of the matrix Xₐ, can be calculated from the vector Y and matrix A, respectively, on a SIMD-type parallel computer architecture with the same instruction issued at the same time. The product of the matrix A and the vector S, and the products necessary to calculate the matrix Tₜ, can all be calculated with existing parallel computer architectures. The decomposition of the matrix Tₜ can also be calculated with existing parallel computer architectures. The coefficient matrix T₀ is not required to be symmetric, real, or have any particular eigenvalue spectrum. The choice of hardware architecture depends on the performance, cost and power constraints of the particular device on which the methods are implemented.

The disclosed methods can be efficiently implemented on circuits that are part of computer architectures that include, but are not limited to a digital signal processor, a general microprocessor, an application specific integrated circuit, a field programmable gate array, and a central processing unit. These computer architectures are portions of devices that require the solution of a system of equations with a coefficient matrix for their operation. The present invention may be embodied in the form of computer code implemented in tangible media such as floppy disks, read only memory, compact disks, hard drives, or other computer-readable storage medium. When the computer program code is loaded into, and executed by a computer processor, the computer processor becomes an apparatus for practicing the invention. When implemented on a computer processor, the computer program code segments configure the processor to create specific logic circuits.

The present invention is not intended to be limited to the details shown. Various modifications may be made in the details without departing from the scope of the invention. Other terms with the same or similar meaning to terms used in this disclosure can be used in place of those terms. The number and arrangement of components can be varied.

1. A solution component comprising digital circuits for processing digital signals, wherein:
said solution component is a component of a device, said device is one of a sensing device, a communications device, a control device, a device comprising an artificial neural network, a speech processing device, an image processing device, an EEG or medical signal processing device, an imaging device, a data compression device, a digital filter device, a system identification device, a linear prediction device, and any general signal processing device;
said device calculates a coefficient matrix T₀ and a vector Y₀;
said solution component calculates at least one signal J from said coefficient matrix T₀ and said vector Y₀, said solution component comprises:
a system transformer for
forming a coefficient matrix T from said coefficient matrix T₀;
separating said coefficient matrix T into a sum of matrix products; and
forming a transformed system of equations;
a system solver for calculating a solution vector X by solving said transformed system of equations; and
a system processor for calculating said at least one signal J from said solution vector X and an at least one signal J₀; and wherein dimensions of said coefficient matrix T are selected for a particular said device.

2. A device as recited in claim 1, wherein said sum of matrix products comprises at least two diagonal matrices.

3. A device as recited in claim 2, wherein said sum of matrix products comprises at least two circulant matrices.

4. A device as recited in claim 1, wherein:
said matrix T has dimensions that are larger than dimensions of said matrix T₀; and
said matrix T has been modified.

5. A device as recited in claim 1, wherein:
said matrix T either has dimensions that are larger than dimensions of said matrix T₀, or has been modified.

6. A device as recited in claim 1, wherein said solution component further comprises an iterator for calculating an update to said solution vector X.

7. A device as recited in claim 1, wherein said system transformer forms a coefficient matrix Tₛ from portions of said coefficient matrix T₀.

8. A device as recited in claim 1, wherein said system transformer calculates a transformed coefficient matrix Tₜ on parallel hardware computing structures.

9. A device as recited in claim 1, wherein said system solver calculates a vector X_{y} and a matrix Xₐ on SIMD-type parallel hardware computing structures.

10. A device as recited in claim 1, wherein said system transformer calculates a transformed vector Yₜ from said vector Y₀ by calculations comprising a fast Fourier transform.

11. A device as recited in claim 1, wherein said vector X and said vector Y₀ are difference vectors that each represent a difference between two vectors.

12. A method for processing digital signals, said digital signals including at least one of digital signals representing: images, speech, noise, data, target information including identity, position, velocity and composition, sensor aperture data, and a physical state of an object including structural damages, medical data, position, velocity, flow characteristics, and temperature, said method comprising the steps of:
forming a coefficient matrix T from a coefficient matrix T₀, wherein said coefficient matrix T₀ is calculated from said digital signals;
calculating a transformed vector Yₜ from calculations comprising a fast Fourier transform and a vector formed from said digital signals;
separating said coefficient matrix T into a sum of matrix products comprising diagonal and circulant matrices;
calculating a transformed coefficient matrix Tₜ from said sum of matrix products;
calculating a solution vector X from said transformed coefficient matrix Tₜ and said transformed vector Yₜ; and
calculating at least one signal J from said solution vector X and at least one signal J₀.

13. A method as recited in claim 12, wherein said step of:
calculating a transformed coefficient matrix Tₜ is performed on a parallel hardware computing structure; and
calculating a solution vector X further comprises calculating a vector X_{y} and a matrix Xₐ, on a SIMD-type parallel hardware computing structure.

14. A method as recited in claim 13, said method further comprising the step of calculating an iterative update for said solution vector X.

15. A digital signal processing device comprising digital circuits for processing digital signals that include digital signals representing physical target characteristics, a physical state of an object or animal, transmitted images, speech and data, digitized images and data, and training signals for an artificial neural network, said digital signal processing device comprising:
a first input component for collecting one or more signals;
a first processor component for processing said one or more signals;
a second processor component for calculating a coefficient matrix T₀ and a vector Y₀ from signals received from said first processor component;
a solution component for calculating at least one signal J from said coefficient matrix T₀ and said vector Y₀,
wherein,
said solution component comprises:
a system transformer for
forming a coefficient matrix T from said coefficient matrix T₀;
separating said coefficient matrix T into a sum of matrix products comprising diagonal matrices and circulant matrices, and
forming a transformed system of equations;
a system solver for determining a solution vector X by solving said transformed system of equations; and
a system processor for calculating at least one signal J from said solution vector X and at least one signal J₀; and
a third processor component for performing calculations comprising said signal J; and
a first output component.

16. A device as recited in claim 15, wherein:
said digital signal processing device is one of a radar and a sonar system;
said first input component is a sensor array;
said coefficient matrix T is formed from sampled data from said sensor array;
said vector Y₀ is one of a steering vector, received data vector and an arbitrary vector;
said vector X comprises signal weights; and
said at least one signal J forms a beam pattern.

17. A device as recited in claim 15, wherein:
said digital signal processing device controls mechanical, chemical, biological and electrical systems;
said first input component is a sensor;
said coefficient matrix T and said vector Y₀ are formed from signals that are either collected from said sensor, or signals associated with a physical object;
said vector X comprises filter coefficients; and
said at least one signal J is a control signal.

18. A device as recited in claim 15, wherein:
said digital signal processing device is one of an echo canceller, equalizer, and a device for channel estimation, carrier frequency correction, speech encoding, mitigating intersymbol interference, and user detection;
said coefficient matrix T and said vector Y₀ are formed from said digital signals representing transmitted images, speech and data;
said vector X comprises filter coefficients; and
said at least one signal J is a filtered signal.

19. A device as recited in claim 15, wherein:
said digital signal processing device calculates synapse weights in an artificial neural network;
said second processor component calculates a coefficient matrix T₀ by forming an autocorrelation from training signals, and calculates a vector Y₀ by forming a crosscorrelation with a signal representing a desired response from said training signals;
said vector X comprises synapse weights for a Toeplitz synapse matrix; and
said system processor comprises an artificial neural network including said vector X as synapse weights.

20. A device as recited in claim 15, wherein dimensions of said coefficient matrix T are specifically chosen for a particular said digital signal processing device.
